(19) United States
(12) Patent Application Publication
(10) Pub. No.: US 2022/0333222 A1
(43) Pub. Date: Oct. 20, 2022

(54) FATIGUE IMPROVED HARVESTER COMPONENT VIA LASER SHOCK PEENING

(71) Applicants: Casey Placek, Van Dyne, WI (US); Keith A. Johnson, West Bend, WI (US)

(72) Inventors: Casey Placek, Van Dyne, WI (US); Keith A. Johnson, West Bend, WI (US)

(73) Assignee: Kondex Corporation, Lomira, WI (US)

(21) Appl. No.: 17/592,039

(22) Filed: Feb. 3, 2022

Related U.S. Application Data
(60) Provisional application No. 63/174,867, filed on Apr. 14, 2021.

(51) Int. Cl. C21D 10/00; C21D 9/00; B23K 26/356; B26D 1/00

(52) U.S. Cl. CPC C21D 10/005; C21D 9/0068; B23K 26/356; B26D 1/0006

(57) ABSTRACT

Laser shock peening is applied to a harvester component for an agricultural wear application that for example may be any of the following components: a knifeback, a knifehead, a knifeback connecting strap, a straw chopper, a sickle section, stalk chopper, a bedknife, a sod cutter knife, a net wrap knife or a combine concave component. The laser shock peening may be selectively applied. For example, laser shock peening can be applied in regions of drive ends of harvester components, and/or in regions proximate fastener holes of such harvester components.

### CROSS-REFERENCE TO RELATED PATENT APPLICATIONS

This patent application claims the benefit of U.S. Provisional Patent Application No. 63/174,867, filed Apr. 14, 2021, the entire teachings and disclosure of which are incorporated herein by reference thereto.

### FIELD OF THE INVENTION

The present invention relates to harvester components and methods of fatigue and/or wear resistance in such harvester components, which harvester components may be for any of: knifebacks or other sickle assembly components; other components of grain harvesting equipment; and/or other foliage, grass or crop cutting machines.

### BACKGROUND OF THE INVENTION

In a variety of harvesters, a sickle assembly is known to comprise: a knifeback (that may be a single continuous bar or multiple bar segments), sickle sections, a knifehead, and any accompanying hardware. For example, such knifebacks and sickle assemblies that can incorporate the same are disclosed in the following patent records of the current Assignee: U.S. Publication No. 2021/0015033, entitled Channel Knifeback; U.S. Publication No. 2020/0214197 entitled Sickle section and knifeback and section joint; U.S. Pat. No. 10,648,051 entitled Reciprocating cutting blade with cladding; U.S. Pat. No. 8,371,096 entitled Sickle bar assembly; U.S. Publication No. 2010/0050587 entitled Modular sickle bar with integrated locking system; U.S. Pat. No. 5,161,357 entitled Sickle bar joint splice construction; and U.S. Pat. No. 4,942,728 entitled Sickle bar joint construction. As apparent from the foregoing, sickle sections are typically triangular shaped knives that are bolted in series on to a piece of rectangular bar stock called knifeback. The knifehead of the assembly is what is attached to the driven end of the knifeback, which is configured differently than the non-driven end of the knifeback. The driving force applied at the driven end is what drives the entire bar causing it to reciprocate between stationary counter knives called knifeguards. The reciprocating movement of the sickle assembly between the guards creates a scissor like cutting action. Sickle assemblies are most often used on grain headers for combines as well as mowers for various grasses and foliage.

Knifeback, in its current state, has been around for more than 150 years. In this time, very little has changed. As the size of farms increased, so did that of the machinery used. Driven by the demand for efficiency, knifeback drastically increased in length, the speed at which it could cut, as well as many other improvements. Switching from rivets, to nuts and bolts, as well as the development of new alloys of the knifeback itself proved important to harvesting more crop in less time. These new alloys allowed for more robust mechanical properties, compared to their outdated predecessors. Limitations were ultimately imposed by roads not being able to accommodate these massive machines with equally large headers and accompanying knifeback. The advent of flexible draper headers added yet another hurdle introducing multi-axis loading that knifeback had not yet seen. Merely introducing larger engines in order to drive these massive lengths of knifeback led to an impasse. Something with the knifeback itself had to change. The realization was made, it did not matter how long the knifeback was if it could not withstand the constant abuse of cyclic loading, random impacts with foreign objects, and general wear and tear.

Potential improvements in sickle coupling to knifeback that may also impart fatigue resistance is contemplated by the present Assignee such as in the aforementioned U.S. Publication No. 2020/0214197 entitled Sickle section and knifeback and section joint, which discloses concepts such as non-flat surface regions comprising a plurality of indentations formed therein.

Despite the foregoing, it continues to be that the current state of the art of knifebacks, other sickle assembly component parts and other harvester components is therefore deficient, in that wear and fatigue resistance are less than desirable for the current environment of harvester components as used for combines, mowers, and other similar such harvesters.

### BRIEF SUMMARY OF THE INVENTION

Today, knifeback is typically manufactured from a cold rolled, medium to high carbon steel rectangular bar stock. The material is often softer than 30 HRC with a minimum yield and tensile strength of ˜60 ksi and 100 ksi, respectively.

In an effort to improve mechanical properties of the knifeback, heat treatment was explored. Attempts to heat treat knifeback has been met with many challenges throughout the years. Not only is it difficult to find a large enough furnace to accommodate the longer bars, many in excess of 20 feet, but also distortion control has been a continued area of difficulty.

An aspect of the present invention relates to the enhancement of knifeback via the introduction of compressive residual stresses at and/or near the surface. Other aspects related to the enhancement of other harvester component parts also via the introduction of compressive residual stresses at and/or near the surface

The most common method in which knifeback (or other harvester components) fails is from fatigue. The introduction of compressive residual stresses and increased dislocation densities are critical drivers in preventing crack initiation, crack growth, corrosion, and other fatigue related symptoms.

In accordance with an aspect, a method for making a part, comprises: laser shock peening at least part of a harvester component.

The harvester component may comprise opposed flat sides and fastener holes through opposed flat sides.

For example, the flat sides and holes may be provided by a metal body.

The method may comprise applying the laser shock peening symmetrically on the opposed flat sides, thereby minimizing distortion of the opposed flat sides. In this regard “symmetrically” as used herein means laser shock peening is applied to at least 75% same areas on opposite sides (although more preferably it is typically at least 90% of the same areas on opposite sides).

The method may comprise simultaneous application of the laser shock peening to opposed flat sides of the harvester component.

The harvester component may include opposed edge surfaces extending perpendicular between opposed flat sides. The method may comprise applying the laser shock peening symmetrically on the opposed edge surfaces.

For example, the harvester component can be elongated and include a line of the fastener holes to include a first set proximate a mounting end and a second set distal from the mounting end. The method may further comprises selectively applying the laser shock peening a treated region of the harvester component having the first set of the fastener holes, and avoiding shock peening outside of the treated region to provide an untreated region of the harvester component having the second set of the fastener holes.

The method may comprise applying the laser shock peening along a treated region proximate fastening holes and avoiding the shock peening of an untreated region distal from fastening holes.

The harvester component may be an elongated knifeback including a line of the fastener holes including pairs of fastening holes at sickle mounting locations. The laser shock peening is applied to areas between fastening holes of select pairs of the fastening holes, and wherein regions are untreated of laser shock peening between adjacent select pairs.

The method may comprise applying the laser shock peening along an internal hole surface of fastening holes extending between opposed flat sides.

The method may comprise applying the laser shock peening around select fastener holes to at least cover a peened region of 0.4 centimeters surrounding each of select fastener holes. The laser shock peening may not be applied to an untreated surface region outside of the peened region.

The laser shock peening can be applied to substantially all of the harvester component. For example, “substantially all” as used herein meaning greater than 75% (and is more preferably 90% or more).

The laser shock peening can be advantageously applied to less than 50% of the surface area of the harvester component, and more preferably less than 25% of the surface area of the harvester component. For example, targeted areas of fatigue can be laser shock peened while other areas untreated.

The harvester component may be a knifeback comprising a single continuous elongated knifeback, or an assembly of elongated knifeback sections.

Such knifeback can often have a length of greater than 4 meters. It can be advantageous to apply targeted laser shock peening to a drive end while leaving other select areas free of laser shock peening. For example, laser shock peening may be applied only along a drive end of the knifeback within the first two meters from the drive end, with a distal portion beyond the first two meters being untreated, being free of laser shock peening.

The knifeback can be assembly of elongated knifeback sections where only a first drive end section of the elongated knifeback sections may be laser shock peened at least around the fastening holes in the first drive end section and preferably all of the fastening holes in the first drive end section.

The harvester component can be a knifehead having a collar and a drive arm having fastening holes therein, wherein at least one flat side of a distal region of the drive arm is laser shock peened around fastening holes therein.

In such a knifehead an intermediate region of the drive arm between the distal region and the collar can be untreated, that is not laser shock peened around the fastening holes therein.

The harvester component can be a knifeback connecting strap for connecting between a knifehead and a knifeback. Preferably, substantially all of opposed side surfaces connecting strap is laser shock peened.

The harvester component can be a straw chopper knife that comprises a flat blade having opposed flat sides, with one or more fastener holes through the opposed flat sides, and a beveled edge partially around a periphery and joining the opposed flat sides. The laser shock peening preferably is applied to the opposed flat sides around the hole with regions with less than 50% of a surface area the straw chopper knife being laser shock peened.

The method is particularly advantageous for harvester components made from planar metal sock material such as can be made by configuring planar metal stock material into a harvester component part. For example, the flat metal stock material can be chosen from: steel sheet, steel plate, steel bar or flattened coil steel. Preferably, the planar metal stock material has a thickness between opposed planar sides of between 0.08 and 2.0 centimeters, and more preferably between 0.1 and 0.7 centimeters.

The harvester component is typically for an agricultural wear application and can comprise: a knifeback, a knifehead, a straw chopper, a sickle section, stalk chopper, a bedknife, a sod cutter knife, a net wrap knife or a combine concave component.

The laser shock peening is accomplished by applying an ablative layer to a base workpiece for the harvester component, applying a transparent overlay, and applying a laser beam pulse through the transparent overlay and to the ablative layer to create a shockwave into the workpiece.

An inventive aspect also pertains to a laser shock peened harvester component made according any of one or more of methods and/or structural aspects described above.

Another inventive aspect is directed toward an apparatus, comprising a metal body configured a knifeback, a knifehead, a knifeback connecting strap, a straw chopper, a sickle section, stalk chopper, a bedknife, a sod cutter knife, a net wrap knife or a combine concave component. Further a laser shock peened surface formed into the metal body.

The metal body typically will comprise opposed flat sides and fastener holes through the metal body.

To minimize potential distortion, the metal body can have opposed laser shock peened surface regions that are symmetrically located on opposed sides of the metal body.

The harvester component can be elongated including a line of the fastener holes to include a first set proximate a mounting end and a second set distal from the mounting end. A laser shock peened treated region may be formed into the mounting end and an untreated region resides free of laser shock peening may reside outside of the mounting end.

A fastener hole is defined by the metal body, and wherein a laser shock peened treated region is provided proximate the fastening hole with an untreated region distal from the fastening hole.

For example, multiple fastener holes can be defined by the metal body. Preferably, a laser shock peened treated region is proximate the fastening holes while avoiding the shock peening of an untreated region distal from the fastening holes. Preferably all of the fastener holes have treated regions therearound, although this also encompasses situations where some of select fastener holes are treated therearound, and others select fastener holes are not treated in surrounding relation.

For a fastener hole that is subject to LSP treatment, preferably the laser shock peened treated region at least covers 0.4 centimeters surrounding the fastening hole, and wherein an untreated surface region free of laser shock peening is provided outside of the laser shock peened treated region.

For some parts, the laser shock peened surface can cover substantially all of the metal body. Alternatively, for targeted treatment, the laser shock peened surface covers less than 50% of the surface area of the metal body, and more preferably less than 25% of the surface area of the metal body.

The metal body can be configured as a knifeback comprising a single continuous elongated knifeback (e.g. unitary one-piece component), or an assembly of elongated knifeback sections.

The knifeback can a length of greater than 4 meters, with the laser shock peened surface being along a drive end of the knifeback within the first two meters from the drive end. Further a majority of a distal portion beyond the first two meters may be an untreated surface region that is free of laser shock peening.

The metal body may be configured planar metal stock material chosen from: steel sheet, steel plate, steel bar or flattened coil steel; wherein the planar metal stock material has a thickness between opposed planar sides of between 0.08 and 2.0 centimeters, and more preferably between 0.1 and 0.7 centimeters.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic cross section of laser shock peening of a knifeback using an ablative layer, understanding that the same process can be applied to the opposite side of the knifeback as well;

FIG. 2 is a schematic cross section of laser shock peening of a knifeback without using an ablative layer, understanding that the same process can be applied to the opposite side of the knifeback as well;

FIG. 3 is an exploded isometric assembly view of a sickle bar assembly with darkened regions schematically indicting LSP treatment for 3 different laser shock peened harvester components: a knifeback, a knifehead, and a knifeback connecting strap; and with sickle sections and hardware illustrated;

FIG. 4 is an enlarged view of a portion of FIG. 3;

FIG. 5 is an isometric assembled view of the sickle bar assembly shown in FIG. 4;

FIG. 6 is an enlarged view of a portion of FIG. 5;

FIG. 7 is an isometric view of the laser shock peened knifehead used in FIG. 3;

FIG. 8 is a top view of the knifehead shown in FIG. 7, with darkened regions schematically indicting LSP treatment;

FIG. 9 is a side view of the knifehead shown in FIG. 7;

FIG. 10 is a bottom view of the knifehead shown in FIG. 7, with darkened regions schematically indicting LSP treatment;

FIG. 11 is a graph showing cyclic fatigue testing results of five laser shock peened examples of knifeback (designated LSP), as compared with 3 examples of standard non-peened knifeback, with either punched holes, drilled holes or no holes (blank) as indicated in the Figure (with three test samples indicated for each example);

FIG. 12 is an isometric view of a laser shock peened patterned knifeback according to another embodiment, with darkened regions schematically indicting LSP treatment;

FIGS. 13 and 14 are opposed top and bottom views of the knifeback shown in FIG. 12 illustrating symmetrical laser shock peening application to opposed sides (and at the mounting locations for sickles around the sickle fastener holes), with darkened regions schematically indicting LSP treatment;

FIG. 15 is an isometric view of a laser shock peened knifeback according to another embodiment in which opposed top and bottom sides and sides edges are all laser shock peened, whereby the entire surface of the knifeback may be laser shock peened, with darkening applied to schematically indicate the LSP treatment;

FIG. 16 is an enlarge view of a portion of FIG. 15;

FIG. 17 is an isometric view of a sickle bar assembly incorporating a laser shock peened knifeback similar to that of FIG. 15 in which the entire surface of the knifeback may be laser shock peened;

FIG. 18 an isometric view of a laser shock peened patterned knifeback according to another embodiment having only some regions laser shock peened, with it understood that the same regions are laser shock peened upon the opposite side, with darkened regions schematically indicting LSP treatment;

FIG. 19 is an enlarged view of FIG. 18, with darkened regions schematically indicting LSP treatment;

FIGS. 20-22 are top, side and bottom views of a harvester component in the form of a straw chopper knife with a select region of top and bottom sides laser shock peened around fastener holes, symmetrically, in accordance with another embodiment of the present invention, with darkened regions schematically indicting LSP treatment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

In accordance with an aspect of the present invention, laser shock peening (herein also referenced as “LSP”) is used to create compressive stresses in a harvester component as shown in embodiments herein.

For example, an embodiment is shown in FIG. 1 as a laser shock peened component, illustrated in the form of a knifeback 10 having opposed sides including a top side 12 and a bottom side 14.

LSP is a process that typically employs a high energy pulsed laser beam 16 to deliver short bursts of light to the surface of a work piece, which in this case is the top side 12; however, it is understood that typically the same LSP treatment application may and typically will be also applied to the bottom side 14 as well (either as a separate operation or simultaneously as the top side 12 is being laser shock peened). In FIG. 1, the work piece is often coated with an ablative layer/opaque layer 18 (such as dark marker, black paint, tape or similar darkening of the surface) and subsequently covered with an inertial tampering layer/transparent layer 20 (such as water, glass, other liquid, transparent overlay or other material transparent to the laser beam).

The laser beam 16 passes through the transparent layer 20 and impacts the opaque layer 18. Upon impact, the laser generates an expanding plasma. Due to the confinement of the transparent overlay, the shockwaves 22 are imparted into the work piece. The shockwaves work their way in to the metal substrate, plastically deforming the material on a microstructural level. The microstructure surrounding the area of impact is forced to adjust to accommodate the new plastic strain. Although the surrounding untreated area adapts to the expanding treated area, the untreated area is still attempting to move back to its original position/orientation. These countering forces ultimately lead to the creation of compressive residual stresses.

It has been found that LSP has several advantages, perhaps significantly is the depth at which the compressive residual stresses can be applied. For example, LSP can achieve depths far greater than those as compared with shot peening such harvester components for example, upwards of 10×. This allows for better fatigue life due to a higher chance of mitigating crack propagation, particularly around fastener holes.

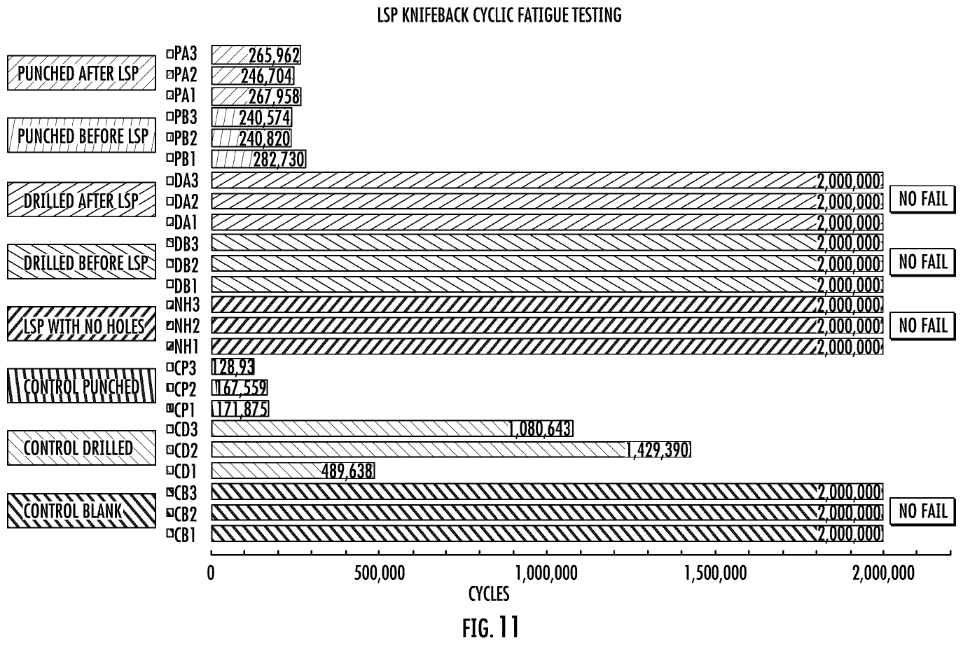

In this regard, the application is particularly significant to harvester components that have fastener holes, where cracks or breaks can propagate leading to component part failure. For example, in reference to FIG. 11, cyclic fatigue testing was applied to typical steel knifeback samples, some with holes (drilled or punched); and some without holes (“no holes” or “control blank”); and that some of the samples according to the present inventive concept were subject to laser shock peen treatment on opposite sides. As can be seen, both the control blank and the LSP treated blank without holes passed testing. It is only when holes were formed that issues arose from the testing. Further as can be seen, whether the holes were punched or drilled (either before or after LSP treatment), the LSP treatment increased fatigue testing cycle performance significantly.

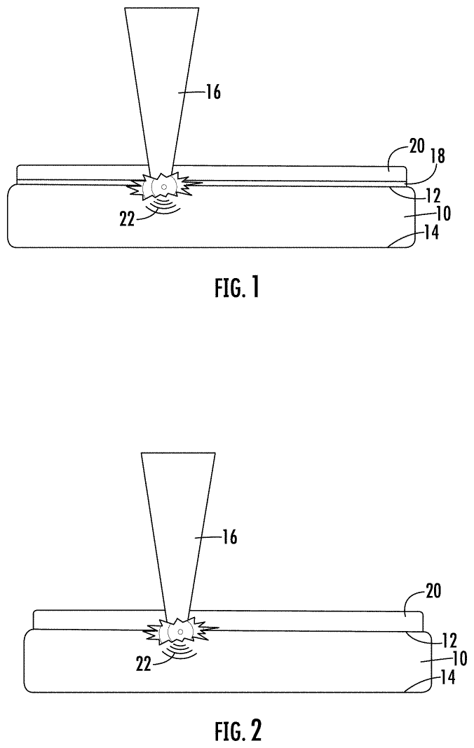

It should be noted that the use of the ablative/opaque layer 18 may not be necessary for a successful LSP treatment, and is considered optional, and that is shown in FIG. 2 where the LSP treatment is applied without an ablative layer, as an alternative embodiment. It also being understood in FIG. 2 that typically the same LSP treatment application may and typically will be also applied to the bottom side 14 as well (either as a separate operation or simultaneously as the top side 12 is being laser shock peened).

It may be that only the top and bottom sides 12 and 14 may be laser shock peened. Optionally, in either FIG. 1 or 2, optionally longitudinal side edges may also be shock peened as can be seen in the embodiment in 15 and 16.

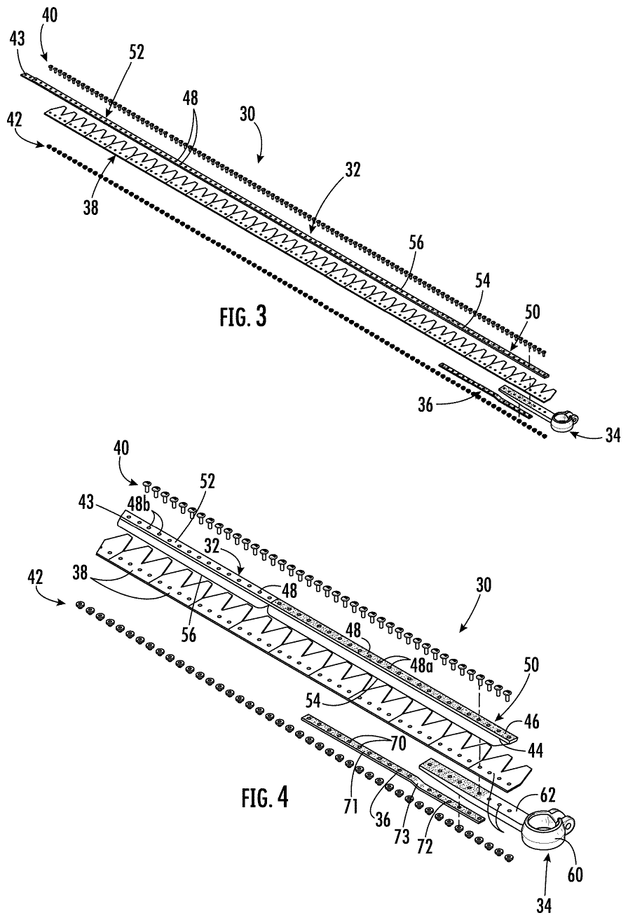

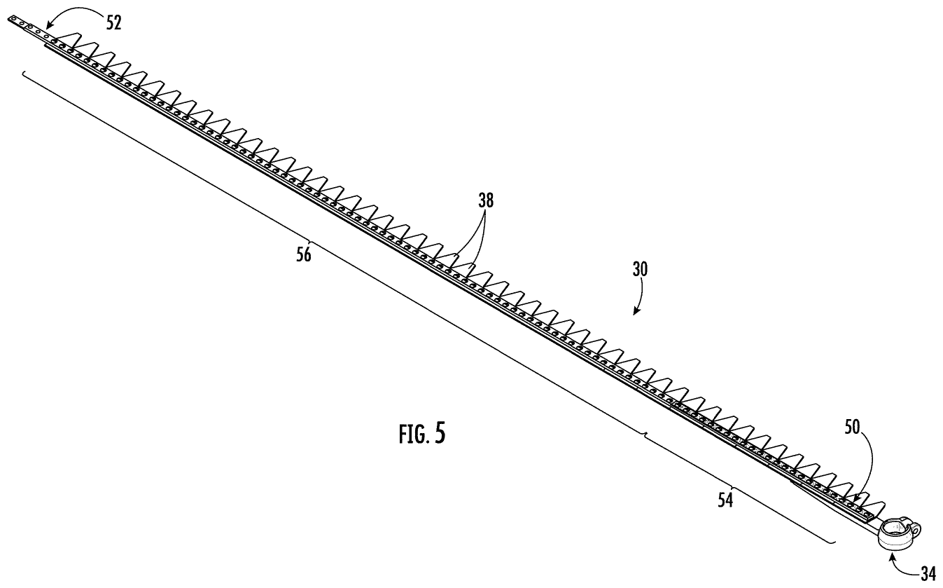

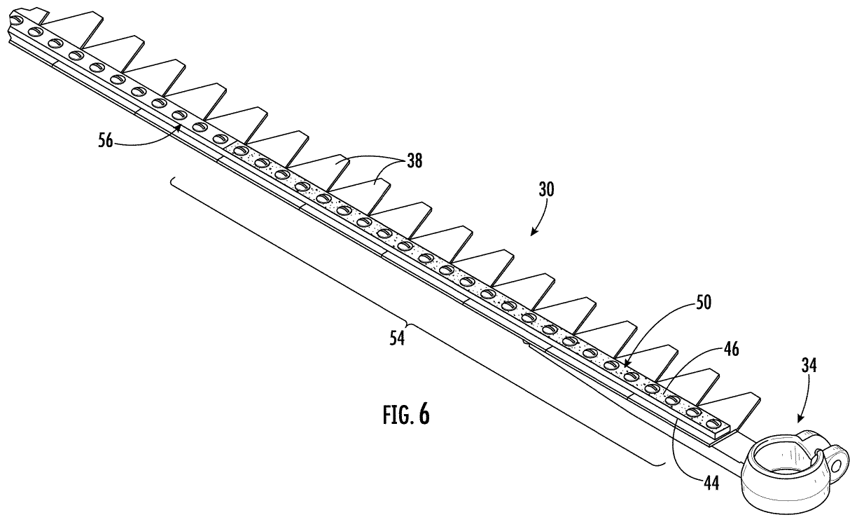

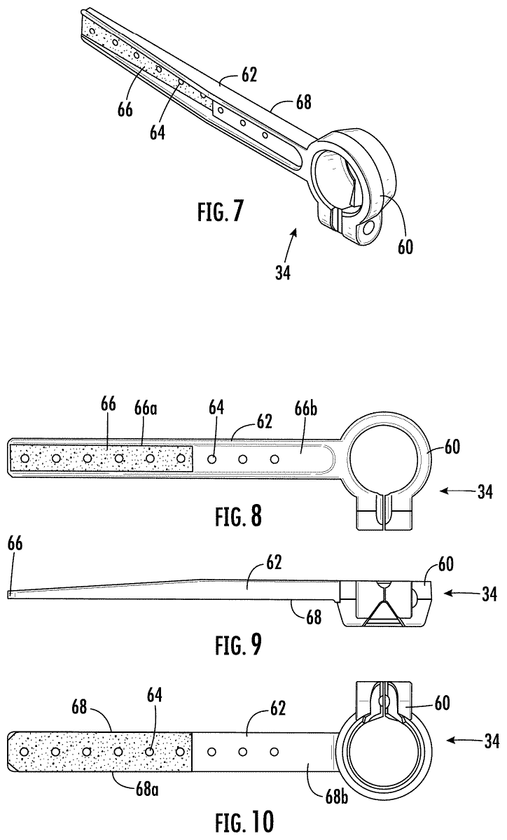

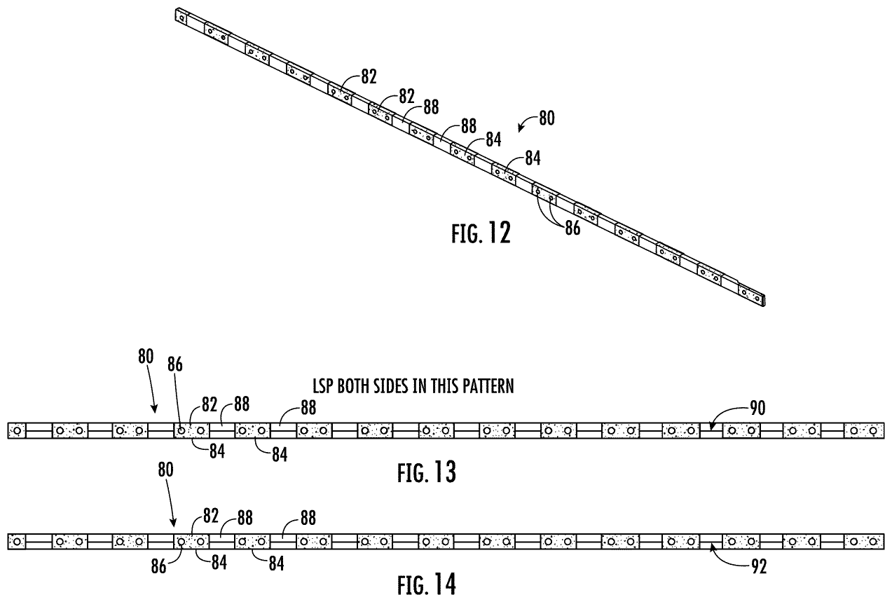

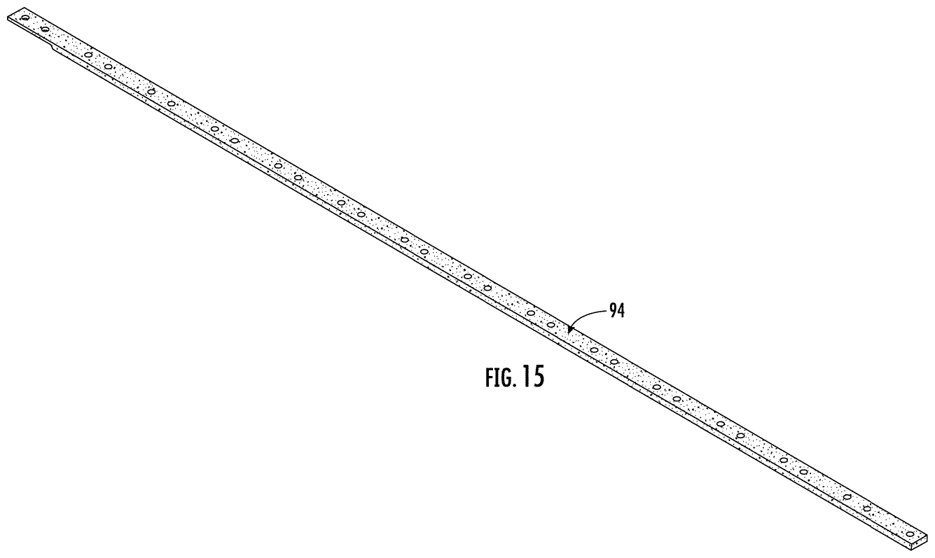

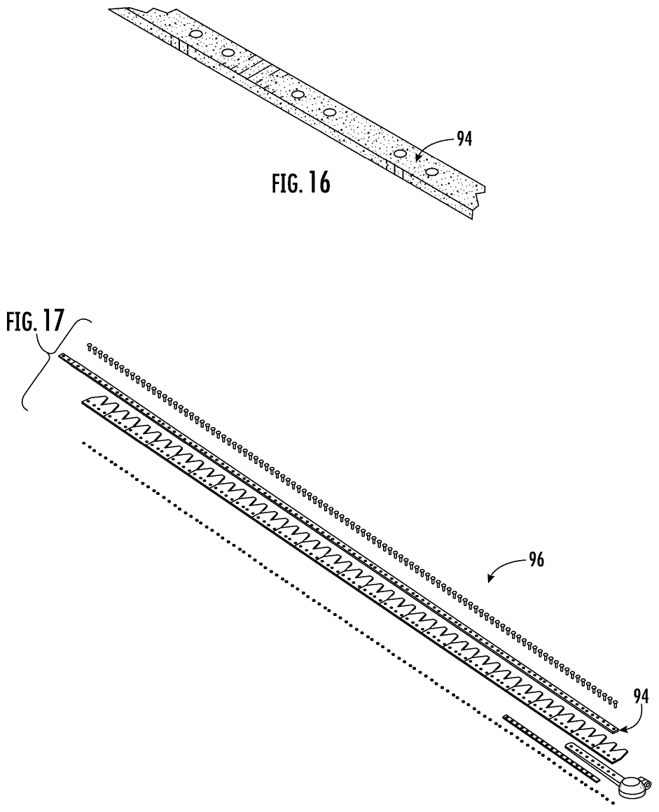

Optionally, the inner annular surface (for example, cylindrical surface) of fastener holes as shown in the embodiment of any of the FIGS. 3-10, 11-22 may be laser shock peened as an addition or alternative to surfaces of outer top and bottom sides 12, 14.

It is recognized that Laser Shock Peening is known in other industries subject to much different environments, and not concerned with the particular issues or problems of harvester components. Further details of Laser Shock Peening treatments and/or reference on part fatigue/failure may be found in: U.S. Pat. No. 6,664,506 to Clauer et al., entitled METHOD USING LASER SHOCK PROCESSING TO PROVIDE IMPROVED RESIDUAL STRESS PROFILE CHARACTERISTICS; and in the following publications:
a. LASER SHOCK PEENING FOR FATIGUE RESISTANCE Allan H. Clauer LSP Technologies, Inc. 6145 B Scherers Place Dublin, Ohio 43016-1272 (Published 1996);
b. Laser Peening vs. Shot Peening: engineering of residual stresses, surface roughness and cold working, Higounenc 1 1 Metal Improvement Company I Curtiss Wright Surface Technologies, Bayonne, France; and
c. Understanding How Components Fail; Second Edition; Donald J. Wulpi; Copyright 2000, ASM International (Published November, 1999).

As may be seen, a component that has been laser shock peened is structurally different as may be realized from different analytics such as: amount of residual stresses measured using x-ray/electron diffraction techniques; Depth of residual stresses measured using x-ray/electron diffraction techniques; tensile fatigue strength measured using fatigue testing techniques; and/or other analytical techniques.

Different embodiments that have been laser shock peened treated according to the methods of FIG. 1 or 2 (and/or as otherwise indicated above), are illustrated in FIGS. 3-10 and 12-22. In each of these embodiments, it is seen that the harvester component may comprise opposed flat sides and may include fastener holes in the harvester component (e.g. for receipt of bolts, rivets or other such similar fasteners). As shown in these embodiments, the laser shock peening has been typically applied symmetrically on the opposed flat sides, thereby minimizing distortion of the opposed flat sides (although there may be some harvester component applications where asymmetrical peening is advantageous and is done intentionally).

For example, laser application applied to only one side of an elongated knifeback may create distortion and undesired curvature, which is avoided through symmetrical application that offset distortion created through compressive stresses imparted by LSP treatment. By “symmetrically” it is meant that laser shock peening is applied to at least 75% same areas on opposite sides, and it may be at least 90%, and even more preferably entirely symmetrical that is 100% (i.e. the same exact areas on both sides).

To minimize distortion, it is contemplated that the laser shock peening is simultaneously applied to the opposed flat sides, preferably in the same areas at the same time.

Typically, the LSP treatment is applied after configuring flat metal stock material into a harvester component part (the fastener holes may be drilled before or after such configuration, and sharpening if needed for some components such as knives can be done before or after). The flat metal stock material used for the illustrated embodiments of FIGS. 1-22 are medium to high carbon steel, which may typically be cold rolled steel (except that for knifeheads, the material may be cast or forged steel or cast iron rather than flat metal stock to provide for flat sides that can be LSP treated). The steel material is often softer than 30 HRC with a minimum yield and tensile strength of ˜60 ksi and 100 ksi, respectively. The flat metal stock material chosen from: steel sheet, steel plate, steel bar or flattened coil steel; wherein the planar metal stock material has a thickness between opposed planar sides of between 0.08 and 2.0 centimeters, and more preferably between 0.1 and 0.7 centimeters.

Different LSP treated components are illustrated in FIGS. 3-10 and 12-22, including various knifeback embodiments, knifeheads, knifeback connecting straps and a straw chopper knife.

A variety of harvester components may be contemplated for LSP treatment for various agricultural wear applications such as: a knifeback, a knifehead, a straw chopper, a sickle section, stalk chopper, a bedknife, a sod cutter knife, a net wrap knife or a combine concave component.

As will be apparent in different embodiments of FIGS. 3-10 and 12-22, some select regions (especially around and/or in holes) are LSP treated, and/or select regions such as mounting regions and/or drive end regions.

However, for some applications such as the knifeback connecting strap (and some knifeback embodiments and other applications), substantially all of the harvester component has been LSP treated (“substantially all” meaning greater than 75% of the surface area, inclusive of a more preferable range of 90%-100%). For example, substantially of the surfaces are LSP treated in for the connecting strap in FIGS. 2-3, and the knifeback embodiments of FIGS. 15-17.

Referring now to FIGS. 3-10, an embodiment of the present invention is illustrated as a sickle bar assembly 30, including an LSP treated knifeback 32, an LSP treated knifehead 34, an LSP treated connecting strap 36, a plurality of sickles 38 and a plurality of fasteners that may take the form of bolts 40 and nuts 42.

The LSP treated knifeback 32 comprises an elongated steel bar 43 having opposed flat sides including top surface 44 and bottom surface 46. Formed into the bar 43 are fastener holes 48 that may be punched (or more preferably drilled) that receive the bolts therethrough to couple the sickles 38 thereto, and to couple a drive end 50 of the knifeback 32 that provides a mounting end to the knifehead 34. As apparent, there is a first set 48a of fastener holes proximate the drive end 50, and a second set 48b of fastener holes distal therefrom at toward the non-driven end 52 away from driven end 50. As apparent, the LSP treatment has been selectively applied to a treated region 54, while a second untreated region 56 (avoiding LSP treatment) is outside of the treated region 54.

The treated region 54 preferably comprises within the first 4 feet and typically between 2-4 feet in elongated length from the terminating end of the driven end 50, as this is a region is more prone to propagation of stress cracks and cyclically fatigue failure being at the driven location. Thus, the LSP treatment at this targeted location reduces failure, although the LSP treatment may extend beyond 4 feet in other embodiments.

Preferably, substantially all of the steel surface of the treated region is LSP treated, at least on both the top surface 44 and the bottom surface 46 are LSP treated at the drive end in the treated region. In this manner, LSP treatment can be symmetrically applied to both the top and bottom surfaces 44, 46, and as such distortion of the elongated nature of the knifeback (that is for example often more than 10 feet and can be 20 feet in more in many embodiments) is avoided.

Longitudinally extending edge surfaces provided by vertical longitudinal portions of edges along the treated region may also optionally be LSP treated and/or the inner cylindrical surfaces of the fastener holes 48 may also optionally be LSP treated.

Alternatively, in the treated region 54, the immediate regions around fastener holes may be treated while areas farther away and outside of the holes are avoided from LSP treatment. For example, the laser shock peening may be conducted around select fastener holes 48 to at least cover a peened region of 0.4 centimeters surrounding each of select fastener holes 48, while the laser shock peening may not be applied to an untreated surface region outside of the peened region.

For example, the laser shock peening can be applied along a treated region proximate the fastening holes and avoiding the shock peening of an untreated region distal from the fastening holes. In this example, the driven end 50 is considered to still have the LSP treated region 54, which may be for example within the first 4 feet at the mounting end to the knifeback 32, while the non-driven end 52 may be entirely free of LSP treatment in the non-treated region 56.

In either case, it is seen that the laser shock peening has applied to less than 50% of the surface area of a harvester component, and in fact less than 25% of the surface area of the knifeback.

For the illustrated knifeback 32, it may be a single continuous elongated knifeback which is typical for OEM applications; but may be an assembly of elongated knifeback sections to form the knifeback, which sometimes is more typical for replacement/aftermarket applications. When the knifeback 32 is the assembly of elongated knifeback sections, only a first drive end section of the elongated knifeback sections may be laser shock peened at least around all of fastening holes in the first drive end section, and potentially substantially all of the first drive end section.

The LSP treated knifehead 34 comprises a mounting collar 60 (for coupling to an actuated reciprocating drive) and a drive arm 62 having fastening holes 64 therein. The drive arm 62 includes opposed top and bottom flat sides 66, 68, of which each has a distal region 66a, 68a which is LSP treated and is directly coupled to the knifeback 32 (at least being laser shock peened around fastening holes 64 therein); while a thicker intermediate region 66b and 68b proximate the collar 60 may be left untreated (e.g. not laser shock peened around the fastening holes therein). This also provides LSP treatment in a targeted fatigue failure area in the knifehead, where it may be thinner between oppose top and bottom flat sides 66, 68.

A further harvester component that may also LSP treated in FIGS. 3-6 is the knifeback connecting strap 36 the reinforces and thereby is for connecting between the knifehead 34 and the knifeback 32, and as can be seen substantially all of opposed side surfaces of the knifeback connecting strap 36 is laser shock peened. Optionally, vertical edges may not be LSP treated, nor intermediate diagonal offsetting portion 73. However, the strap connection portions with fastener holes 70 to include offset portions 71, 72 to the knifeback and the knifehead are LSP treated at least partially, preferably on both top and bottom sides, and preferably entirely along at least the horizontal portions as shown.

Turning to FIGS. 12-17, alternative embodiments of knifebacks are illustrated, which are the same as that of the earlier embodiment other than as indicated, such that the prior description is applicable to these embodiments.

In the embodiment of FIG. 12, a knifeback 80 is illustrated with mounting locations 82 for mounting the sickles (e.g. sickles 38 as in FIG. 3), where the mounting locations 82 are LSP treated around (and optionally into) the fastening holes 86 so that the fastening holes have LSP treatment at least within 0.4 centimeters of the fastening holes 86, and untreated regions 88 that avoid LSP treatment are between mounting locations 82. Also as shown, top and bottom sides 90, 92 are symmetrically LSP treated at the same exact locations, corresponding to the mounting locations 82.

In this embodiment, even regions distal from the drive end may be LSP treated at least around holes; and optionally a greater region of the drive end may be LSP treated, similar to the first embodiment.

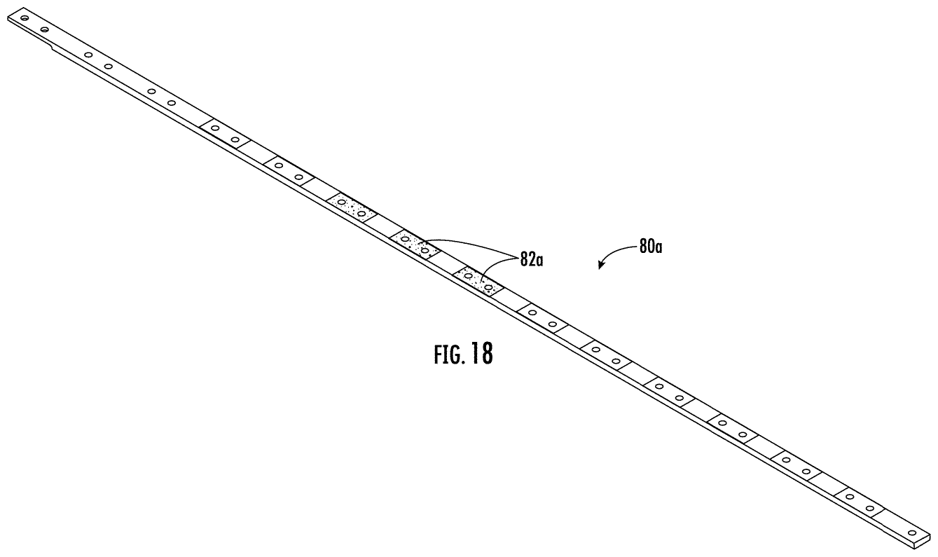

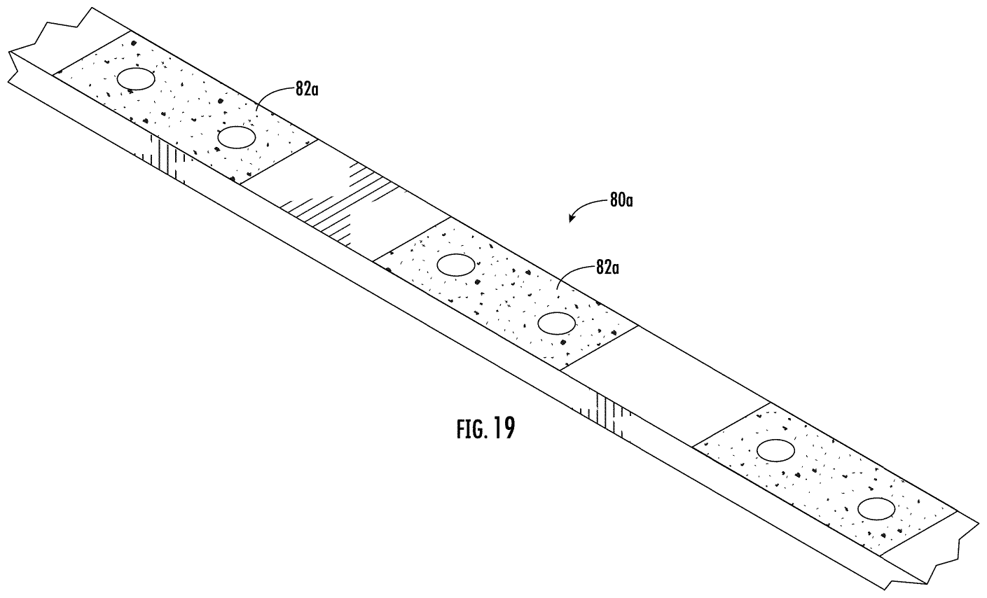

In FIGS. 18-19 only 3 mounting locations 82a are LSP treated for the knifeback 80a as a further embodiment.

In FIGS. 15-17, the entire knifeback 94 is LSP treated (e.g. top and bottom sides and preferably all four longitudinally extending sides as including the two opposed longitudinally extending vertical edges). Thus, regions distal from the drive end can be LSP treated too as shown in FIG. 17, in the assembled sickle bar assembly.

It is appreciated that other harvester components can be LSP treated in regions at least around fastener holes.

Therefore, as used herein “harvester” includes traditional combine harvesters and forage harvesters, but also includes other reapers, mowers and turf equipment that also process grass or other foliage with sickles, cutters and knives. Therefore, “harvester component” being for an agricultural wear application encompasses for example any of the following components: a knifeback, a knifehead, a knifeback connecting strap, a straw chopper, a sickle section, stalk chopper, a bedknife, a sod cutter knife, a net wrap knife or a combine concave component.

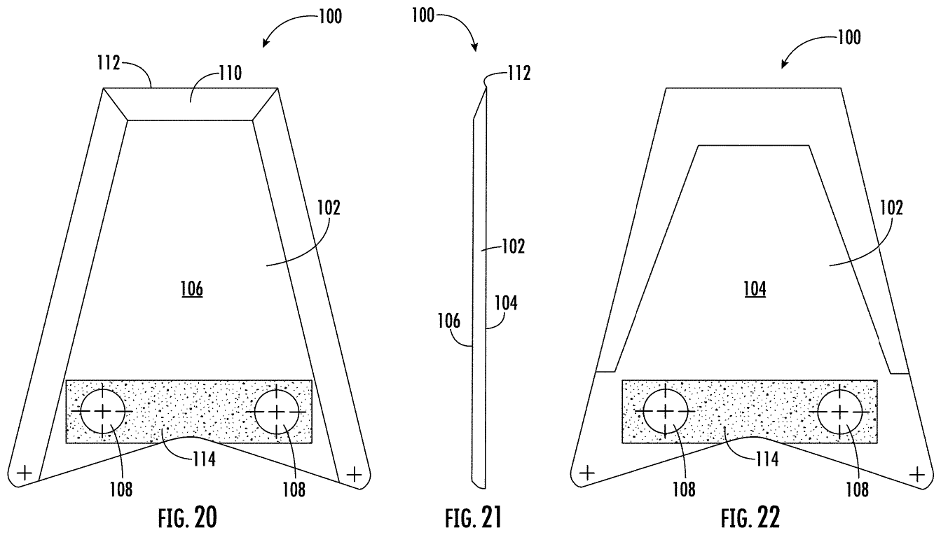

For example, in FIGS. 20-22, the harvester component is a straw chopper knife 100, which comprises a flat blade 102 having opposed flat sides 104, 106, with a pair of fastener holes 108 through the opposed flat sides 104, 106. A beveled edge 110 extends partially around a periphery and joins the opposed flat sides 104, 106. As illustrated schematically, the laser shock peening has been applied in LSP treated regions 114 to at least one side and preferably symmetrically the opposed flat sides, in areas around the fastening holes. As can be seen, LSP treated regions 114 are less than 50% (for example less than 25%) of the surface area of the straw chopper knife 100.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Unless otherwise indicated or readily apparent from context, the term “or” as used herein is an inclusive or that means “either this, or that, or both.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for making a part, comprising: laser shock peening at least part of a harvester component.

2. The method of claim 1, wherein the harvester component comprises opposed flat sides and fastener holes through opposed flat sides.

3. The method of claim 2, comprising applying the laser shock peening symmetrically on the opposed flat sides, thereby minimizing distortion of the opposed flat sides.

4. The method of claim 3, wherein the laser shock peening is simultaneously applied to the opposed flat sides.

5. The method of claim 3, wherein the harvester component includes opposed edge surfaces extending perpendicular between the opposed flat sides, further comprising applying the laser shock peening symmetrically on the opposed edge surfaces.

6. The method of claim 2, wherein the harvester component is elongated including a line of the fastener holes to include a first set proximate a mounting end and a second set distal from the mounting end, wherein the method comprises selectively applying the laser shock peening a treated region of the harvester component having the first set of the fastener holes, and avoiding shock peening outside of the treated region to provide an untreated region of the harvester component having the second set of the fastener holes.

7. The method of claim 2, further comprising applying the laser shock peening along a treated region proximate the fastening holes and avoiding the shock peening of an untreated region distal from the fastening holes.

8. The method of claim 7, wherein the harvester component is an elongated knifeback including a line of the fastener holes including pairs of fastening holes at sickle mounting locations, wherein the laser shock peening is applied to areas between fastening holes of select pairs of the fastening holes, and wherein regions are untreated of laser shock peening between adjacent select pairs.

9. The method of claim 2, comprising applying the laser shock peening along an internal hole surface extending between the opposed flat sides.

10. The method of claim 2, comprising applying the laser shock peening around select fastener holes to at least cover a peened region of 0.4 centimeters surrounding each of select fastener holes, and wherein the laser shock peening is not applied to an untreated surface region outside of the peened region.

11. The method of claim 1, wherein the laser shock peening is applied to substantially all of the harvester component.

12. The method of claim 1, wherein the laser shock peening is applied to less than 50% of the surface area of the harvester component, more preferably less than 25% of the surface area of the harvester component.

13. The method of claim 1, wherein the harvester component is a knifeback comprising a single continuous elongated knifeback, or an assembly of elongated knifeback sections.

14. The method of claim 13, wherein the knifeback has a length of greater than 4 meters, and wherein laser shock peening is applied only along a drive end of the knifeback within the first two meters from the drive end, wherein a distal portion beyond the first two meters is untreated, being free of laser shock peening.

15. The method of claim 13, wherein the knifeback is the assembly of elongated knifeback sections, and where only a first drive end section of the elongated knifeback sections is laser shock peened at least around the fastening holes in the first drive end section.

16. The method of claim 1, wherein the harvester component is a knifehead having a collar and a drive arm having fastening holes therein, wherein at least one flat side of a distal region of the drive arm is laser shock peened around fastening holes therein.

17. The method of claim 16, wherein an intermediate region of the drive arm between the distal region and the collar is not laser shock peened around the fastening holes therein.

18. The method of claim 1, wherein the harvester component is a knifeback connecting strap for connecting between a knifehead and a knifeback, further wherein substantially all of opposed side surfaces connecting strap is laser shock peened.

19. The method of claim 1, wherein the harvester component is a straw chopper knife that comprises a flat blade having opposed flat sides, one or more fastener holes through the opposed flat sides, and a beveled edge partially around a periphery and joining the opposed flat sides, the laser shock peening applied to the opposed flat sides around the hole with regions with less than 50% of a surface area the straw chopper knife being laser shock peened.

20. The method of claim 1, further comprising configuring planar metal stock material into a harvester component part, the flat metal stock material chosen from: steel sheet, steel plate, steel bar or flattened coil steel; wherein the planar metal stock material has a thickness between opposed planar sides of between 0.08 and 2.0 centimeters, and more preferably between 0.1 and 0.7 centimeters.

21. The method of claim 1, wherein the harvester component is for an agricultural wear application and comprises: a knifeback, a knifehead, a straw chopper, a sickle section, stalk chopper, a bedknife, a sod cutter knife, a net wrap knife or a combine concave component.

22. The method of claim 1, wherein the laser shock peening is accomplished by applying an ablative layer to a base workpiece for the harvester component, applying a transparent overlay, and applying a laser beam pulse through the transparent overlay and to the ablative layer to create a shockwave into the workpiece.

23. A laser shock peened harvester component made according to the method of claim 1.

24. An apparatus, comprising,
a metal body configured as a knifeback, a knifehead, a knifeback connecting strap, a straw chopper, a sickle section, stalk chopper, a bedknife, a sod cutter knife, a net wrap knife or a combine concave component; and
a laser shock peened surface formed into the metal body.

25. The apparatus of claim 24, wherein the metal body comprises opposed flat sides and fastener holes through the metal body.

26. The apparatus of claim 24, wherein the metal body has opposed laser shock peened surface regions that are symmetrically located on opposed sides of the metal body.

27. The apparatus of claim 24, wherein the harvester component is elongated including a line of the fastener holes to include a first set proximate a mounting end and a second set distal from the mounting end, wherein a laser shock peened treated region is formed into the mounting end and an untreated region resides free of laser shock peening resides outside of the mounting end.

28. The apparatus of claim 24, wherein a fastener hole is defined by the metal body, and wherein a laser shock peened treated region is provided proximate the fastening hole with an untreated region distal from the fastening hole.

29. The apparatus of claim 28, wherein the laser shock peened treated region at least covers 0.4 centimeters surrounding the fastening hole, and wherein an untreated surface region free of laser shock peening is provided outside of the laser shock peened treated region.

30. The apparatus of claim 24, wherein the laser shock peened surface covers substantially all of the metal body.

31. The apparatus of claim 24, wherein the laser shock peened surface covers less than 50% of the surface area of the metal body, more preferably less than 25% of the surface area of the metal body.

32. The apparatus of claim 24, wherein the metal body is configured as a knifeback comprising a single continuous elongated knifeback, or an assembly of elongated knifeback sections.

33. The apparatus of claim 32, wherein the knifeback has a length of greater than 4 meters, and wherein the laser shock peened surface is along a drive end of the knifeback within the first two meters from the drive end, wherein a majority of a distal portion beyond the first two meters is an untreated surface region that is free of laser shock peening.

34. The apparatus of claim 24, wherein the metal body is configured from planar metal stock material chosen from: steel sheet, steel plate, steel bar or flattened coil steel; wherein the planar metal stock material has a thickness between opposed planar sides of between 0.08 and 2.0 centimeters, and more preferably between 0.1 and 0.7 centimeters.
